(19) United States
(12) Patent Application Publication
(10) Pub. No.: US 2018/0024073 A1
(43) Pub. Date: Jan. 25, 2018

(54) REACH-EXTENDED TEST STRIP

(71) Applicant: RONALD SCHORNSTEIN, Mountain Lakes, NJ (US)

(72) Inventor: RONALD SCHORNSTEIN, Mountain Lakes, NJ (US)

(21) Appl. No.: 15/215,958

(22) Filed: Jul. 21, 2016

(51) Int. Cl. G01N 21/78; B01L 3/00; B01L 9/00

(52) U.S. Cl. CPC G01N 21/78; B01L 9/52; B01L 3/52; B01L 2300/069; B01L 2200/141; G01N 2021/7796

(57) ABSTRACT

The present invention is directed to a device that extends the reach of a test strip, and to an analytical method that provides for assembly and use of the device. The inventive device is based on a combination of a test strip and test strip packaging that enables the reach of a test strip to be extended.

### FIELD OF THE INVENTION

The present invention relates to analysis of fluids using test strips.

### BACKGROUND OF THE INVENTION

Test strips for the analysis of fluids have a wide range of applicability, and are useful for analysis of various fluid parameters and contaminating analytes. These fluids include water, water-based fluids such as water-based coolant fluids, and organic fluids such as brake fluid. Water, including drinking water, is analyzed for a wide variety of parameters using commercially available test strips. Other illustrative fluids analyzed using commercially available test strips, include radiator fluids, brake fluids, power steering fluids, transmission fluids, diesel exhaust fluids and differential fluids.

A typical length of commercially available test strips is about 3 to 4.25 inches. As a result, in some applications, a user cannot grasp the handle end of a test strip, and successfully dip the reagent end of the test strip into a fluid to be analyzed. Thus, prior art approaches include extending the reach of a test strip by inserting the handle end of a test strip into a tube such as a coffee stirrer, or grasping the handle end with a gripping tool such as pliers or the like.

Another approach has been to remove a sample of the fluid using a syringe or the like. For example, to determine if there has been oil contamination to a diesel exhaust fluid tank, an approach has been to remove a sample of diesel exhaust fluid from the tank using a syringe, and to transfer the sample into a vial prior to immersing the test strip pads into the sample. As used herein, the term “pad” means an absorptive matrix.

Furthermore, it is common to test for several fluid parameters using a single test strip. For example, the CTS-4 4-Way HD Antifreeze Cool Check® test strip available from Acustrip Company, Inc. Mountain Lakes, N.J. includes four test strip pads for measuring different fluid parameters. These pads are arranged in a spaced apart relationship along the test strip length, and extend to about half of the length of the test strip. As can be readily understood, the reach of a test strip is even more limited when multiple pads are present in that a greater extent of the test strip must be contacted with the fluid.

Although test strips can be made to be longer, none of these approaches, which typically require additional equipment, is commercially satisfactory. Thus, a better solution is needed to overcome the problem of limited test strip reach.

Moreover, analytical results can be compromised by inadvertent contact of test strip pads with contaminants such as oil or moisture on fingers. Unintended contamination of test strip pads is more likely in an environment where fluids such as radiator fluids, brake fluids and transmission fluids are tested.

As a result of incomplete or inadequate contact of all test strip pads with the fluid or of inadvertent pad contamination, accurate and consistent analytical results are compromised. Accordingly, there is a need for an improved technology for overcoming the limited reach of test strips, that in addition reduces the likelihood of pad contamination resulting from unintended touch-contact.

### SUMMARY OF THE INVENTION

The inventive technology extends the reach of a test strip without the drawbacks of prior art approaches, and includes analytical methods that provide for assembly and use of inventive devices. Furthermore, the inventive technology reduces the likelihood of pad contamination when assembling the inventive devices.

A beneficial device in accordance with the invention, is based on a combination of a test strip and test strip packaging that enables the reach of the test strip to be extended. The analytical methods especially benefit the analysis of a fluid contained within a normally closed enclosure provided with an opening through which a test strip may be extended.

A useful test strip includes a support and at least one reagent-bearing absorptive matrix attached to the support. The support is beneficially an elongated support, and at least one reagent-bearing absorptive matrix is attached to the reagent end of the support.

A suitable test strip package beneficially is likewise elongated. The test strip package is dimensionally sized to initially contain a test strip, and is made to be opened to remove the test strip, as illustrated by a tear-away end. In this embodiment, to provide for test strip removability from a test strip package without inadvertent touch-contact with a reagent-bearing absorptive matrix, the reagent end of a test strip is disposed within the end of the test strip package opposite the tear-away end. When a test strip is removed from a test strip package by the handle end of the test strip support and the device is assembled, an inventive device advantageously includes the handle end adhered to the exterior surface of a test strip package.

In a preferred embodiment, an exterior surface of a test strip package may comprise an adhesive area initially covered by a removable non-cling layer. Because the handle end of the support is used to pressure the test strip into contact with the adhesive, a user can avoid unintended contact with test strip pads on the reagent end of the support when assembling an inventive device. When assembled, the combination of a test strip and a test strip package results in an appropriately positioned test strip having an extended reach.

In a modification that utilizes an extent of an adhesive area that is greater than the test strip width, and a foldable test strip package, an assembled device in accordance with the invention may further include a facing surface of the folded test strip package in pressured contact with the adhesive area. In this modification, the test strip package may be folded generally along the longitudinal axis or a longitudinal mid-line.

In accordance with a related inventive analytical method, a test strip package is opened conveniently by use of a tear-away end, and a test strip is removed from the opened end of the test strip package by use of the handle end of the test strip support. Thereafter, the test strip may be appropriately positioned with respect to the test strip package, and the handle end is assembled to the test strip package by pressure contact of the handle end with the adhesive area, thereby making a reach-extended inventive device.

Thereafter, in accordance with the related inventive method, the reach-extended test strip may be extended into contact with the fluid so that the test strip pad or pads are dipped into the fluid. Thereafter, the test strip is withdrawn from contact with the fluid, and developed color on the test strip pad(s) is evaluated, usually by comparison with a color chart.

Beneficially, in accordance with the inventive technology, the reach of test strips is extended, and unintended contact with test strip pads is minimized when assembling the inventive device. In a modification, a backing member to which the test strip package may be removably attached, may be used to further extend the reach of a test strip.

Additional advantages and beneficial features of the present invention are set forth in the drawing and detailed description, and in part will become apparent to those skilled in the art upon examination of the drawing and detailed description or may be learned by practice of the invention. As will be realized, this invention is capable of other and different embodiments than those described, and its several details are capable of modification in various respects, all without departing from the invention. Accordingly, the drawing and the detailed description are to be regarded as illustrative in nature, and not as restrictive.

### BRIEF DESCRIPTION OF THE DRAWING

Reference now is made to the accompanying drawing which forms a part of the specification of the present invention.

FIG. 1 is a front view of a preferred embodiment of a device in accordance with the present invention, which indicates modifications in phantom line; and

FIG. 2 is a front view of the test strip package used to make the device of FIG. 1, with a portion of the test strip package cut away to expose a portion of the test strip within, and with a modification of the test strip package indicated in phantom line.

### DETAILED DESCRIPTION OF THE INVENTION

The present invention is useful for testing a variety of fluids where contact of a test strip pad or pads with a fluid is problematic due to limited reach of the test strip especially including where a multiplicity of test strip pads extend along a substantial extent of the test strip length. These fluids include water, water-based fluids and organic fluids.

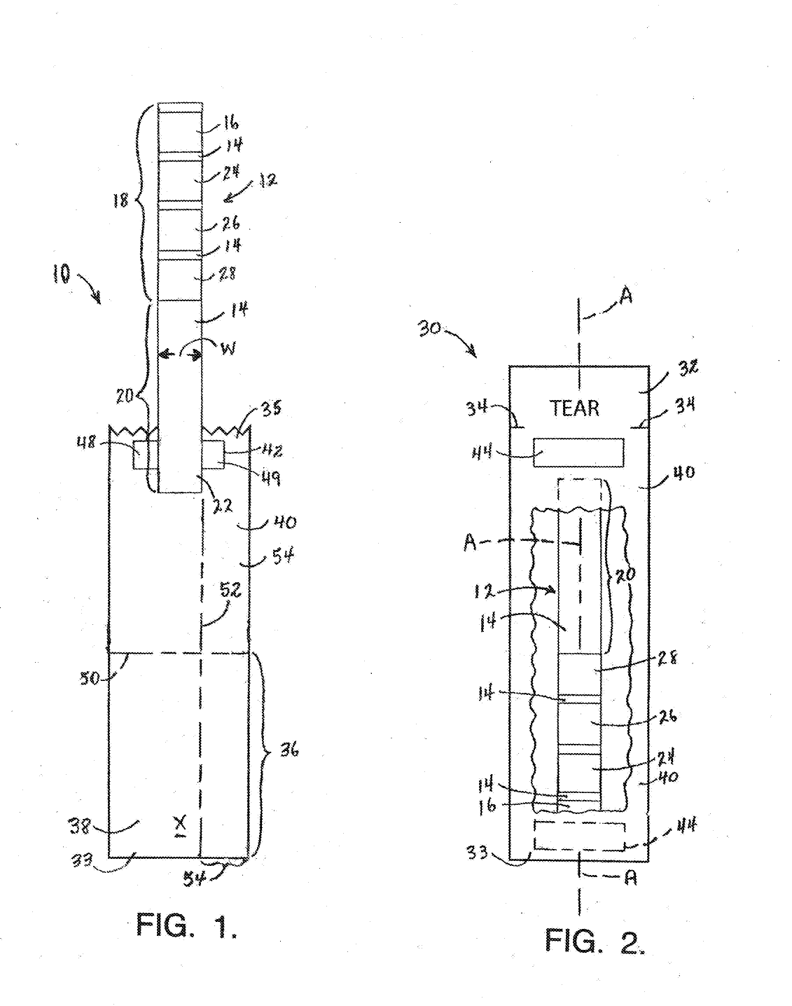

Referring to FIG. 1, a device 10 in accordance with the present invention, includes a test strip 12 comprising a support 14 and at least one reagent-bearing absorptive matrix 16 attached to the test strip support. Depending upon the analysis to be performed, two or several reagent-bearing absorptive matrices may be attached to the support, and may extend more than one-fourth or one-third, even to about one-half, of the length of the test strip support. As illustrated, device 10 comprises additional test pads 24, 26, 28 spaced apart along the length of the support, and these pads extend to about one-half of the length of the support.

Various materials may be used as the support, with preferred materials for economy being available at low cost. The support may be conveniently made of a plastic as illustrated by an opaque thermoplastic such as PVC, and is typically white, but may be made of paper. If desired, the support may be made of a transparent material or be colored.

Although the test strip support may have a variety of shapes, for purposes of the present invention, an elongated support (illustrated in FIG. 1) is beneficial. The term “elongated support”, as used herein, means a support of greater length than width. Accordingly, the term “strip” as used herein, has a meaning of like scope.

The terms “length” and “width” as used herein, are related dimensions, with the term “length” used to refer to the relatively longer dimension, and the term “width” used to refer to the relatively shorter dimension. A typical length of a suitable support is about 3 to 4.25 inches, and a typical width of a suitable support is about 0.25 to 0.50 inches. However, supports of other lengths and widths may be used.

At least one reagent-bearing absorptive matrix is typically attached to an end 18 of the elongated support, which may be referred to as the reagent end of the support. Opposite reagent end 18, is a handle end 20 of the support. As indicated by the drawing, and understood by one skilled in the art, the handle end of a support is free of test strip pads.

Like the support, a useful absorptive matrix may typically be opaque. Useful absorptive matrix materials for test strips are well known, and include cellulose filtration materials and other absorptive fibrous matrices and filter papers.

Suitable test strip reagents are described in the prior art, and include colorimetric indicators, with selection depending upon the analyte or analytes of interest. Suitable test strips for use in the present invention are commercially available from Acustrip Company, Inc., Mountain Lakes, N.J., and are illustrated by test strips including one, two or more reagent-bearing absorptive matrices useful for testing water quality, radiator fluid, brake fluid, transmission fluid and diesel exhaust fluid.

Referring to FIG. 2, the inventive device of FIG. 1 is made using a test strip package 30 that beneficially is likewise elongated, and of greater length and width than the test strip support so as to be capable of containing the test strip. The test strip package is conveniently a foil or plastic package, and conveniently may include a tear-away end 32 to allow removal of a test strip from the test strip package. The tear-away end is indicated by a tear line 34. The test strip package typically is generally flat and generally planar, and may be a pouch. Test strip packages of this type are commercially available.

Typically, a test strip package in accordance with the present invention, will contain only one test strip. If desired, several test strip packages each containing one test strip, may be attached together with a perforated separator. In addition, in a preferred embodiment, a test strip package may, if desired, be removably affixed, for instance by adhesion, to a suitable generally planar backing member (not shown) such as 80 pound paper stock that may be coated paper stock and include a color chart and directions for use of the test strip.

Packaging one or a limited number of test strips in the described test strip package enables a test strip or a limited number of test strips, typically not more than three or four, to be sealed in a closed environment until ready to be used within a limited time period, typically less than one hour. A benefit is minimizing contamination or diminished test strip quality that can result from using a test strip removed from a bottle containing multiple test strips, such as commercially available bottles of 50 or 100 test strips intended to be closed and re-opened over an extended period of time.

With continued reference to FIG. 2, test strip 12 is removably contained, advantageously sealed, within the test strip package conveniently away from tear-away end 32. For removability of a test strip without touch-contact with a reagent-bearing pad, the reagent end of the test strip is beneficially disposed within an end 36 (shown in FIG. 1) of the test strip package opposite the tear-away end. Thus, when test strip package 30 is opened, a test strip may be removed from the package by use of handle end 20. The term “touch-contact”, as used herein, means skin contact, in particular finger contact, which is the most likely contact, and is to be avoided due to natural or contaminating oil or moisture on the hands or fingers.

In the embodiment illustrated, an exterior surface 40 of the test strip package may comprise an adhesive area 42 (shown in FIG. 1) beneficially covered by a removable non-cling film 44. Adhesive area 42 may be advantageously located adjacent tear-away end 32, or adjacent closed end 33 as indicated by the modification shown in FIG. 2 by phantom line and reference numeral 44. The term “adjacent”, as used herein, means close to or bordering. Nearness to end 32 or end 33 benefits relatively greater reach of a reach-extended test strip of inventive device 10. However, if otherwise convenient or desired, it is not necessary that the adhesive area be adjacent end 32 or end 33.

The adhesive area may conveniently be a layer provided by a double-faced adhesive material such as double stick tape. However, adhesive may be applied to the exterior surface of the test strip package in any other suitable way. The adhesive area may have an extent approximately equal to, or greater than, width W (shown in FIG. 1) of the test strip support, and advantageously has a width that provides sufficient contact area for adhesion of the support.

With continued reference to FIG. 2 and the embodiment illustrated, in preparation for assembly of device 10, the test strip package is opened, film 44 is removed to uncover the underlying adhesive area, and a test strip is removed from the test strip package by use of handle end 20 of the test strip.

As previously described, it is beneficial for test strips and the test strip packages to be elongated. As such, test strip 12 and test strip package 30 each have a longitudinal axis defined by the elongated dimension or length. The longitudinal axis of test strip package 30 is indicated in FIG. 2 by a phantom line A, which also indicates the longitudinal axis of test strip 12.

Referring again to FIG. 1, in an assembled state, it is generally beneficial for the longitudinal axis of a test strip to be generally aligned with the longitudinal axis of the test strip package, as illustrated in FIG. 1, to maximize the reach of the test strip of device 10. However, if helpful, the longitudinal axis of the test strip may be oriented at a selected obtuse angle relative to the longitudinal axis of the package.

Regardless of the relative alignment of test strip 12 and test strip package 30, handle end 20 of support 14 is advantageously assembled to exterior surface 40 of the test strip package by adhesion to adhesive area 42. The reach of the test strip of device 10 may be benefitted by adhering the handle end to the test strip package near end 22 of support 14 as illustrated in FIG. 1.

With reference to the modifications indicated by phantom fold lines 50,52 in FIG. 1, adhesive area 42 may have a greater extent than the width of support 14, and the test strip package may be foldable. If folded generally along a longitudinal midline 50 that is generally perpendicular to the longitudinal axis of the test strip package, a device in accordance with the invention may further include a facing surface 38 of end 36 of the folded package in pressured contact with otherwise uncovered adhesive areas 48,49 of adhesive area 42. If folded generally along the longitudinal axis (see fold line 52), a device in accordance with the invention may further include adhesive area 49 on a facing surface 54 of the folded package in pressured contact with the handle end of the test strip, and facing surface 54 in pressured contact with adhesive area 48. Either modification may be used to enhance the securing of a test strip to a test strip package. However, because the test strip package length is decreased, and accordingly the reach of the test strip is decreased when fold line 50 is used, use of fold line 52 may be typically preferred.

In accordance with the inventive method and referring again to FIG. 2, device 10 may be made using a package in which test strip 12 is initially contained, or using another available package. As previously described, test strip package 30 is conveniently opened by use of tear-away end 32, and test strip 12 is removed from opened end 35 (shown in FIG. 1) of test strip package 30 by readily accessible handle end 20 of the test strip, and the adhesive area is uncovered. In this embodiment, it is typically preferable, when the adhesive area is adjacent the tear-away end and initially covered, as illustrated in FIG. 2, for the adhesive area to remain covered when opening the test strip package and when removing a test strip from the opened package.

When an initially covered adhesive area is adjacent the tear-away end and the package contains a limited number of test strips and only one test strip is removed before the adhesive area is uncovered for assembly and use of the device of FIG. 1, unintended touch-contact with the adhesive area (which is adjacent the opened end of the package) may occur during removal of the remaining test strips from the test strip package. This problem may arise as a result of a preference to sequentially remove test strips from the package as needed. Thus, an advantage of the adhesive area being adjacent closed end 33 is its distant location from the opened end of the test strip package.

Referring again to FIG. 1, after test strip 12 has been removed from test strip package 30, the longitudinal axis of test strip 12 is oriented in a selected position relative to the longitudinal axis of the test strip package, which may be in a generally aligned orientation as illustrated in FIG. 1. After a test strip has been aligned relative to a test strip package, the handle end of the test strip is assembled to the test strip package by pressure contact thereof with the adhesive area to make a reach-extended test strip in accordance with the present invention.

In modifications where the adhesive area has a greater extent than the width of the support and the test strip package is foldable, the inventive method may further include after assembling the handle end of the support to the test strip package, folding the opened test strip package generally along fold line 52, and pressuring adhesive area 49 into contact with the handle end of the test strip and pressuring facing surface 54 into contact with adhesive area 48. Alternatively, the inventive method may further include folding the opened test strip package generally along longitudinal midline 50 and pressuring facing surface 38 of end 36 of the folded package into contact with adhesive areas 48,49.

In accordance with the inventive method, device 10, advantageously in a longitudinally unfolded and generally planar configuration, may be beneficially grasped near end 33 of the test strip package, in particular at a location distant from the reagent end of the test strip, as illustrated by location X in FIG. 1. In this way, the reach of, for example, an about three inch long test strip, may be extended by about three inches. Thus, in accordance with the inventive technology, the reach of a test strip may be approximately doubled.

The term “distant”, as used herein, means far removed, it being understood that it will generally be desirable to provide a test strip with the relatively greatest reach. For example, in a preferred embodiment when test strip package 30 is removably adhered to a suitable backing member and entirely located within all peripheral borders of the backing member, the test strip package may after removal from the backing member, be re-attached to the backing member in a different location by which a portion of the test strip package extends beyond a peripheral border of the backing member and the reach of a test strip adhered to the test strip package, may be maximized by grasping the backing member at a location distant from the reagent end of the test strip. As mentioned, 80 lb. paper stock may be used as a backing member, but other sufficiently rigid material may be substituted.

The inventive technology is particularly beneficial when an opening of an enclosure through which a test strip is to be extended, is elongated, say, more than half the length of the test strip, or when the fluid level is below the normal level, or when the test strip pads extend to about half the length of the test strip. In any event, in accordance with the inventive technology, the reach of test strip 12 may be extended to provide contact of the reagent-bearing pads with the fluid.

The duration of contact with the fluid is selected to ensure appropriate sensitivity. Within useful limits, a relatively greater contact time may provide relatively more contact, and may thereby increase sensitivity. It will be understood by one skilled in the art that more or less contact time may be appropriate depending on factors including the sensitivity of the test strip, the sensitivity desired, the reagents, the fluid temperature and the analytes.

After fluid contact with the test strip pads, test strip 12 is withdrawn from contact with the fluid. After an appropriate wait time from withdrawal of the test strip from contact with the fluid, developed color on the test strip pads is evaluated, typically by comparison with a color standard such as a color chart.

The wait time depends on factors including the duration of contact with the fluid, the analyte and the fluid temperature. A relatively longer wait time may be needed for a relatively cooler fluid temperature.

Various modifications and combinations have been described; other modifications will be readily apparent to one skilled in the art. The present invention may be carried out with other modifications and/or combinations without departing from the spirit or essential attributes thereof. Accordingly, reference should be made to the appended claims as indicating the scope of the invention.

1. A device for extending the reach of a test strip, comprising
in an unassembled state, a test strip comprising an elongated support comprising a handle end and at least one reagent-bearing absorptive matrix attached to an opposing end of the support, and
a test strip package wherein said test strip is removably contained within said test strip package, and the reagent-bearing end of said support is disposed within an end of said test strip package opposite an end that is devised to be opened for removability of said test strip from said test strip package by said handle end of said support, and wherein an exterior surface of said test strip package comprises an adhesive area, and
in an assembled state, when said test strip package is opened and said test strip is removed from said test strip package, comprising said handle end of said support adhered to the exterior surface of the opened test strip package by pressured contact with said adhesive area.

2. The device of claim 1, wherein said elongated test strip has a longitudinal axis and said test strip package likewise is elongated and has a longitudinal axis, and in said assembled state, the longitudinal axis of said test strip is in an oriented position relative to the longitudinal axis of said test strip package selected from generally in alignment with, or at an obtuse angle relative to, said longitudinal axis of said test strip package.

3. The device of claim 2, wherein said longitudinal axis of said test strip is generally aligned with said longitudinal axis of said test strip package.

4. The device of claim 1, wherein said test strip package is a foil package, and wherein in said unassembled state, said test strip is sealed within said foil package and said test strip package is a substantially flat pouch.

5. The device of claim 1, wherein a plurality of reagent-bearing absorptive matrices are attached to the reagent end of the test strip support and extend in a spaced apart relationship more than one-third of the length of said test strip support.

6. The device of claim 5, wherein said plurality of absorptive matrices extend to about one-half of the length of said test strip support.

7. The device of claim 1, wherein said end devised to be opened is a tear-away end, and said end of said test strip package opposite said tear-away end is a closed end in said assembled state, and said adhesive area is located adjacent said tear-away end or is located adjacent said closed end.

8. The device of claim 1, wherein the extent of said adhesive area is greater than the test strip width and said test strip package is foldable, and wherein in said assembled state, the device further comprises a facing surface of the opened test strip package in a folded, adhered position.

9. An analytical method
that utilizes a test strip comprising an elongated support that comprises a handle end and at least one reagent-bearing absorptive matrix attached to an opposing end of the support, and a test strip package within which said test strip is removably contained, wherein said test strip package comprises an end devised to be opened for removal of said test strip, and the reagent-bearing end of said support is disposed within an end of said test strip package opposite the end to be opened, and an exterior surface of said test strip package comprises an adhesive area;
said analytical method being beneficial for analysis of a fluid contained within an enclosure comprising an opening through which said test strip may be extended, and comprising
opening said test strip package,
removing said test strip from the opened end of said test strip package without touch-contact with said at least one absorptive matrix, by use of said handle end of said support,
extending the reach of said test strip wherein said handle end of said support is assembled to the opened test strip package by pressure contact of said handle end with said adhesive area and unintended contact with said at least one absorptive matrix is minimized,
extending the reagent end of the reach-extended test strip through the enclosure opening whereby contact with the fluid is made by said at least one absorptive matrix, and
withdrawing said test strip from contact with the fluid and thereafter evaluating the developed color on said test strip.

10. The analytical method of claim 9, wherein said elongated test strip has a longitudinal axis and said test strip package likewise is elongated and has a longitudinal axis, further comprising, prior to the pressure contact of said handle end with said adhesive area, orienting the longitudinal axis of said test strip in a selected position relative to the longitudinal axis of said test strip package.

11. The analytical method of claim 10, wherein said longitudinal axis of said test strip is generally aligned with said longitudinal axis of said test strip package.

12. The analytical method of claim 9, wherein a plurality of reagent-bearing absorptive matrices are attached to the test strip support, and said contact with the fluid is made by said plurality of reagent-bearing absorptive matrices.

13. The analytical method of claim 9, wherein the fluid is selected from radiator fluid, brake fluid, transmission fluid, diesel exhaust fluid, differential fluid and other like fluids for which accurate analysis can be interfered with by inadvertent contamination of said at least one reagent-bearing absorptive matrix.

14. The analytical method of claim 9, wherein a plurality of reagent-bearing absorptive matrices are attached to the reagent end of the test strip support and extend in a spaced apart relationship more than one-third of the length of said test strip support.

15. The analytical method of claim 14, wherein said plurality of absorptive matrices extend to about one-half of the length of said test strip support.

16. The analytical method of claim 9, wherein said test strip package is gripped at a location distant from said reagent end of the test strip when contacting said reach-extended test strip with the fluid.

17. The analytical method of claim 9, wherein said method also utilizes a paper stock backing member to which the test strip package is removably adhered in a first location, said method further comprising prior to contacting said test strip with the fluid, extending the test strip reach by removing the test strip package from the backing member and thereafter re-attaching the test strip package to the backing member in a second location whereby the reach of said test strip is extended by gripping the backing member.

18. The analytical method of claim 9, wherein the extent of said adhesive area is greater than the test strip width and said test strip package is foldable, further comprising after assembling said handle end of said support to said test strip package, folding the opened test strip package, and pressuring a facing surface of the folded test strip package into contact with said adhesive area.
